(19) United States
(12) Patent Application Publication
(10) Pub. No.: US 2009/0153397 A1
(43) Pub. Date: Jun. 18, 2009

(54) GNSS SATELLITE SIGNAL INTERFERENCE HANDLING METHOD AND CORRELATOR IMPLEMENTING THE SAME

(75) Inventors: Kuan-i Li, Kaohsiung City (TW); Zong-hua You, Hsinchu City (TW); An-bang Chen, Taipei City (TW)

Correspondence Address: KIRTON AND MCCONKIE, 60 EAST SOUTH TEMPLE,, SUITE 1800, SALT LAKE CITY, UT, 84111, US

(73) Assignee: MEDIATEK Inc., Hsin-Chu (TW)

(21) Appl. No.: 11/956,757

(22) Filed: Dec. 14, 2007

(51) Int. Cl. G01S 1/00; H04B 1/00

(52) U.S. Cl. 342/357.12; 375/148

(57) ABSTRACT

A GNSS satellite signal handling method is disclosed. For a specific Doppler bin, when a peak is found, it is checked if the specific Doppler bin is polluted with interference by detection. If the detection result indicates that the specific Doppler bin is polluted with interference, a threshold, which is used to determine whether the actual signal peak is found or not, is then raised to a higher level, so as to increase the searching reliability. To detect interference, it is determined whether the specific Doppler bin is polluted by comparing a statistical value of correlation results of a plurality of code chip hypotheses with a reference or by checking if there are plural peaks existing in the power spectrum.

### BACKGROUND OF THE INVENTION

1. Field of the Invention

The present invention relates to GNSS (Global Navigation Satellite System) receiving, more particularly, to an interference handling method for detecting interference and preventing false determination in signal peak searching, and a correlator which implements the above method.

2. Description of the Prior Art

In satellite communication system, such as GNSS, a receiver detects signals from each satellite, The signals of respective satellites are distinguishable by distinct PRN code patterns. The receiver further measures the time delay for each satellite. The receiver produces an identical PRN sequence (i.e. local PRN replica) as that of each satellite. By correlating the input PRN sequence with the local PRN replica, the receiver can measure the delay and calculate its distance to the satellite. A general search scheme for satellite signals is to search for a strong peak within a hypothesized code chip and Doppler search range. Once the strong peak is found. it is deemed that the signal is found, and the search is stopped. However, in some environments, such as urban canyon, the signal strength may become weak. In such circumstances, a peak caused by jamming may be incorrectly determined as the signal peak, resulting in a false determination. As commonly known in this field, there are various interferences such as CW (continuous wave) jamming and PRN (pseudo random noise) jamming or any other types of jamming. PRN jamming is also known as the cross-correlation from the PRN of other strong signals, which are often seen in outdoor environment. Some strong satellite signals may cause difficulties in acquiring other weaker satellite signals. Furthermore, with the modernization of GNSS system, the cross-correlation effect may also exist among different satellite systems.

One method to avoid false determination (or referred to as “false alarm”) is to search over the whole search range and find the maximum peak as the required signal. However, when the search range is quite large or the integration period is long, such a method will take too much time. Another method is to perform FFT (Fast Fourier Transform)of the signal to remove peaks caused by CW (continuous wave) jamming in frequency domain before correlation. Such a method is often implemented by hardware. Because of the high sampling rate of the IF (intermediate frequency) signal, the cost is very high. In addition, the method is only useful for CW jamming but not PRN (pseudo random noise) jamming since the latter can only be observed after correlation, details thereof will be further described.

To overcome PRN jamming, a method is to reproduce the strong satellite IF signal and subtract it from the input signal if the code chip delay, Doppler frequency and power of the present strong signal is known. However, the cost is also very high. In addition, it is not able to find the jamming in the early stage, false determination of the signal may still occur.

As mentioned above, there is a need for an efficient, low-cost scheme to effectively detect interferences and reduce false determination in the present of various kinds of interferences. The present invention satisfies such a need.

### SUMMARY OF THE INVENTION

The present invention is to provide a GNSS satellite signal interference handling method. For a specific Doppler bin, when a peak is found, it is checked if the specific Doppler bin is polluted with interference. To detect interference, it is determined whether a specific Doppler bin of a signal is polluted with jamming or not by comparing a statistical value such as a mean value of correlation results of a plurality of code chip hypotheses with a reference. Alternatively, it is determined whether a specific Doppler bin is polluted with jamming by checking if there are plural peaks existing in the correlation results.

If the detection result indicates that the specific Doppler bin is polluted with interference, a threshold, which is used to determine whether the actual signal peak is found or not, is then raised to a higher value, so as to increase the searching reliability.

The present invention still provides a correlator, which implements GNSS satellite signal interference handling method. Determination operations can be executed by built-in programs of a processor of the correlator. A calculation unit can be added to execute calculation of the statistical value.

### BRIEF DESCRIPTION OF THE DRAWINGS

The present invention will be further described in details in conjunction with the accompanying drawings.

FIG. 1A is a diagram showing the correlation values of the signal peak and the noise floor for the right specific Doppler bin without pollution; while FIG. 1B is a diagram showing the correlation values of code chips for a polluted Doppler bin;

FIG. 2 is a diagram showing a GPS signal after spreading, wherein the GPS signal is polluted with CW jamming;

FIG. 3A is a diagram showing correlation values of the code chip hypotheses for an unpolluted Doppler bin; while FIG. 3B is a diagram showing correlation values of the code chip hypotheses for a polluted Doppler bin;

FIG. 4 is a diagram showing power spectrum density of a signal subjected to CW jamming before spreading;

FIG. 5 shows correlation mean values of the code chip hypotheses of the respective Doppler bins;

FIG. 6 is a flow chart showing a signal peak searching method in accordance with an embodiment of the present invention; and

FIG. 7 is a block diagram showing a correlator of a GNSS receiver in accordance with an embodiment of the present invention.

### DETAILED DESCRIPTION OF THE INVENTION

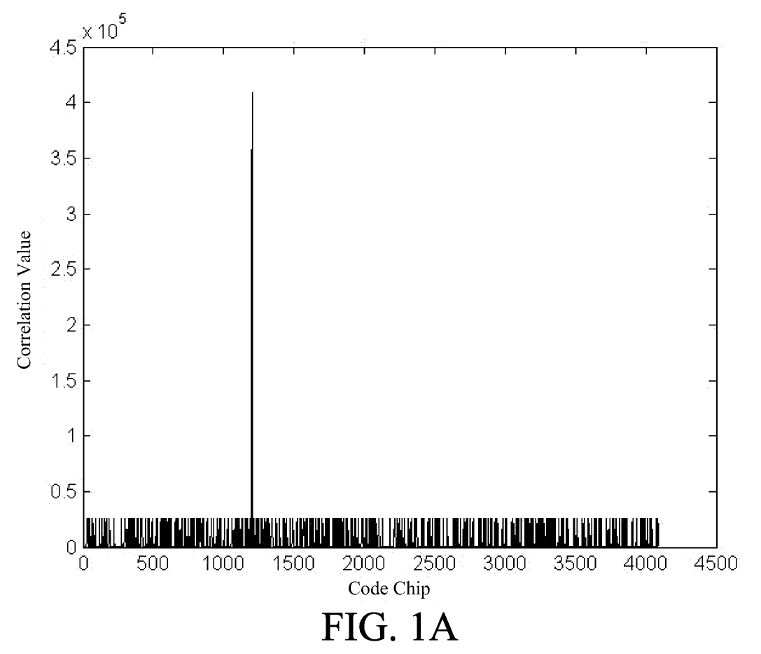

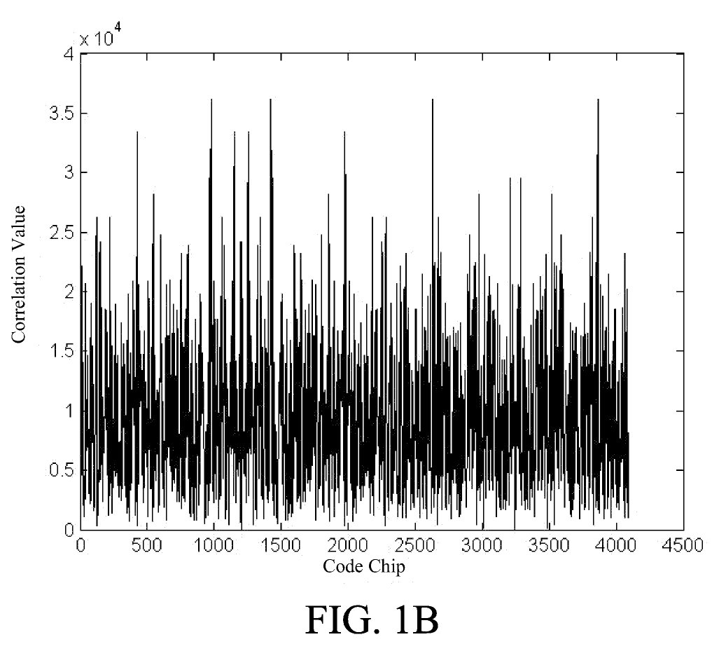

When the signal is subjected to interference from another satellite (another PRN (pseudo random noise) code), in addition to the actual signal peak, there are sub-peaks appearing on multiple code chips for respective Doppler bins, which are 1 kHz apart from each other. This is known as “PRN jamming”. The sub-peaks caused by strong PRN jamming can be higher than the noise floor and lead to false alarm in signal searching or jeopardize tracking reliability. FIG. 1A is a diagram showing the correlation values of the signal peak and the noise floor for the right specific Doppler bin for the GPS signal without pollution. FIG. 1B is a diagram showing the correlation values of code chips for a polluted Doppler bin. As can be seen from these drawings, the sub-peaks on the polluted Doppler bins are considerably higher than the noise floor. When the signal strength is sufficiently strong, the signal peak will be significantly higher than any other sub-peak by at least 24 dB, for example. That is, the C/A code cross-correlation is 24 dB weaker than the main peak. However, when the signal strength of a target satellite is very weak, the signal peak will be of a low value. Under such a condition, the presence of any other strong satellite signal will cause severe PRN jamming, resulting in difficulties in acquiring the target signal or even false acquisition.

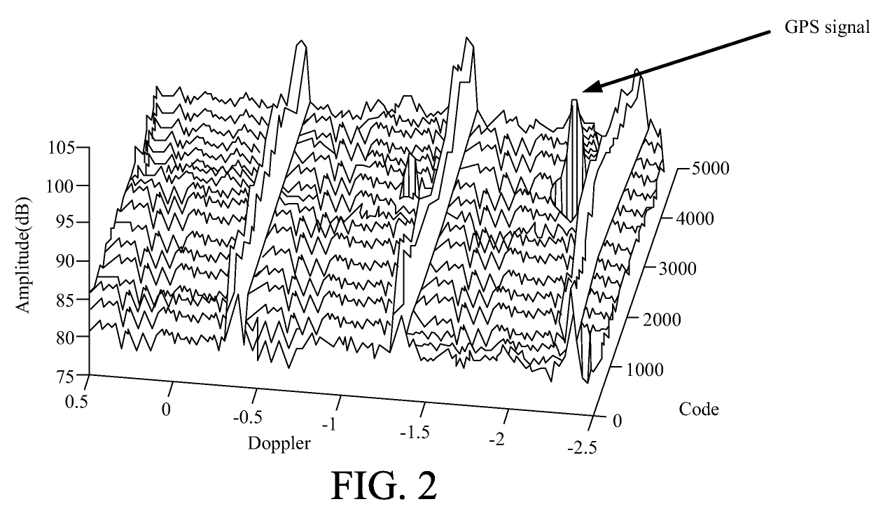

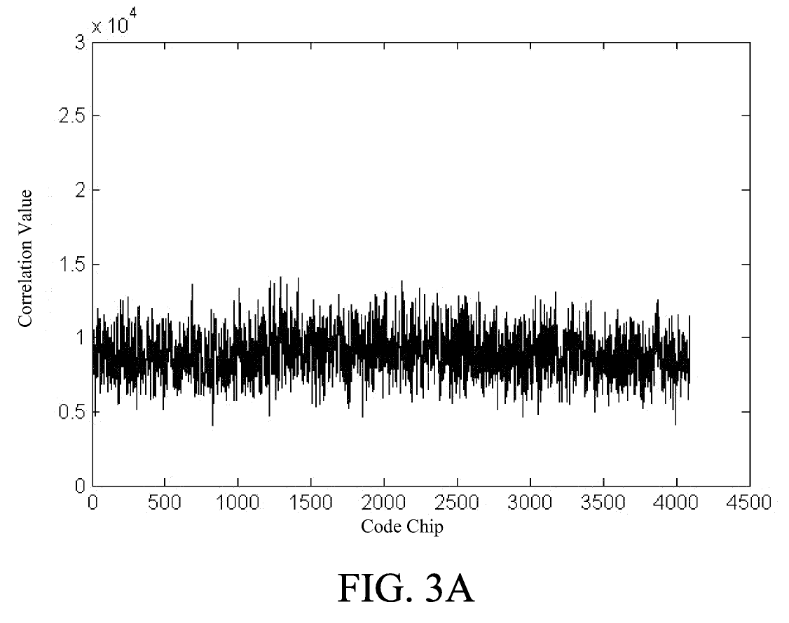

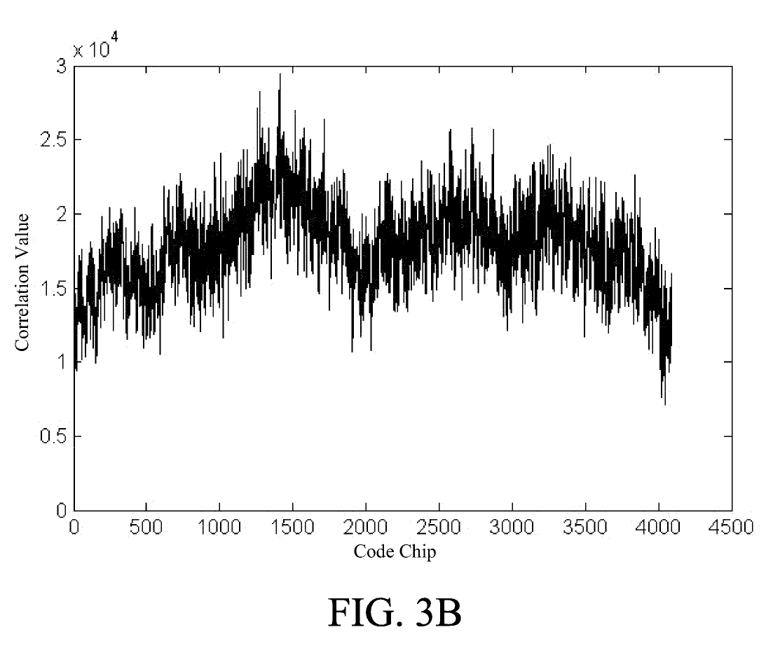

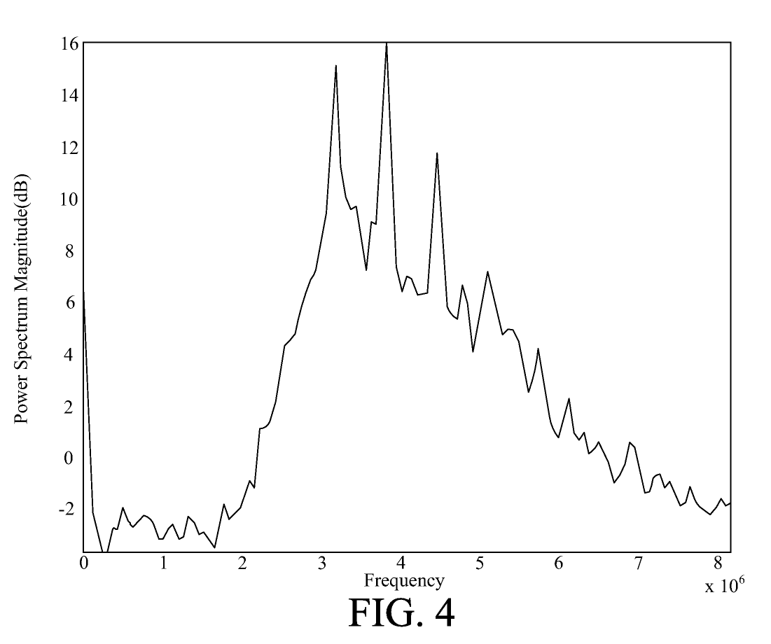

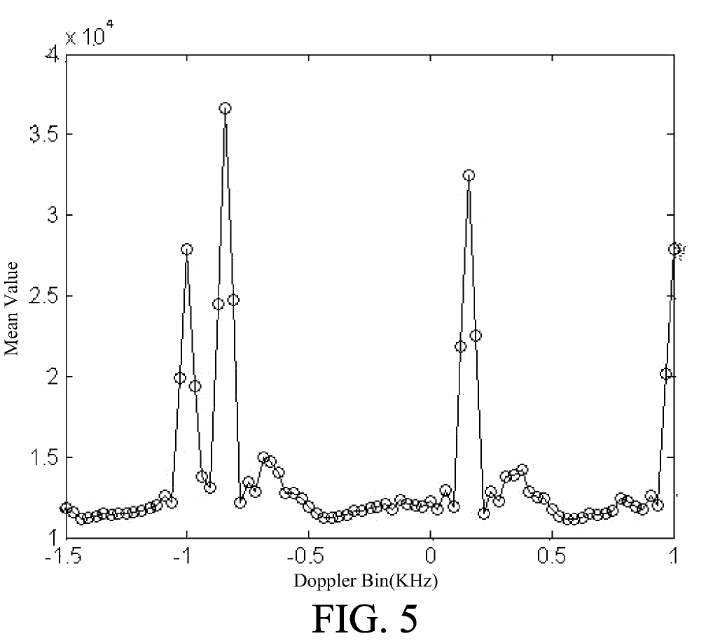

FIG. 2 is a diagram showing a GPS signal after spreading, the GPS signal is polluted with CW (continuous wave) jamming. The so-called CW jamming means interferences caused by harmonics from other sources such as mobile cellular/processor, hostile sources and so on. The CW jamming causes several sub-peaks appearing on some Doppler bins. For an unpolluted Doppler bin, the correlation values of the code chip hypotheses are as shown in FIG. 3A. For a polluted Doppler bin, the correlation values of the code chip hypotheses are significantly higher and sub-peaks appear, as shown in FIG. 3B. FIG. 4 shows power spectrum density of a signal subjected to CW jamming before spreading. FIG. 5 shows correlation mean values of the code chip hypotheses of the respective Doppler bins. As shown, on the polluted Doppler bin, the means of correlation values of the code chips are higher than those on unpolluted Doppler bins.

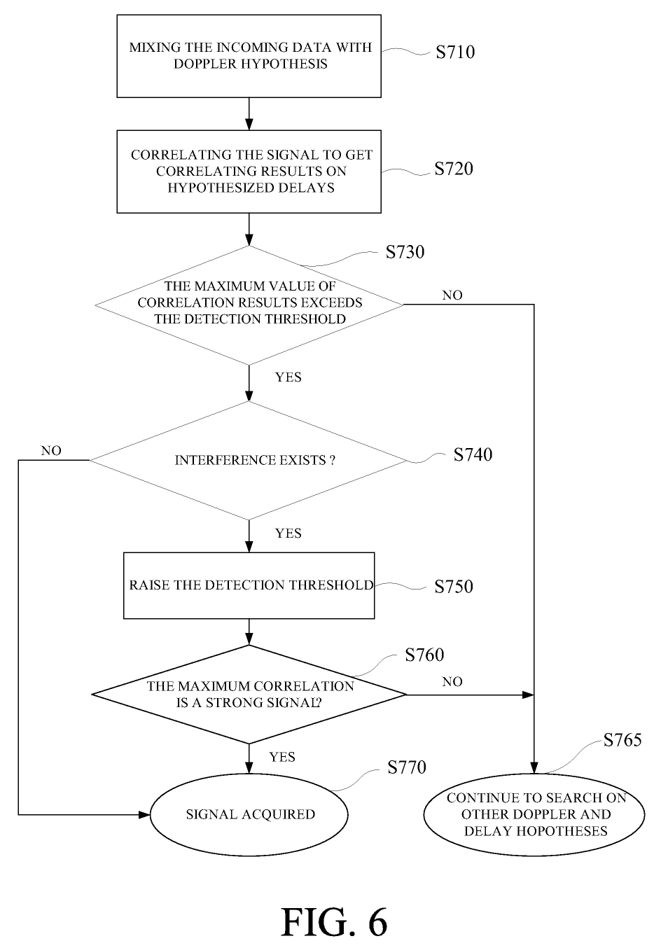

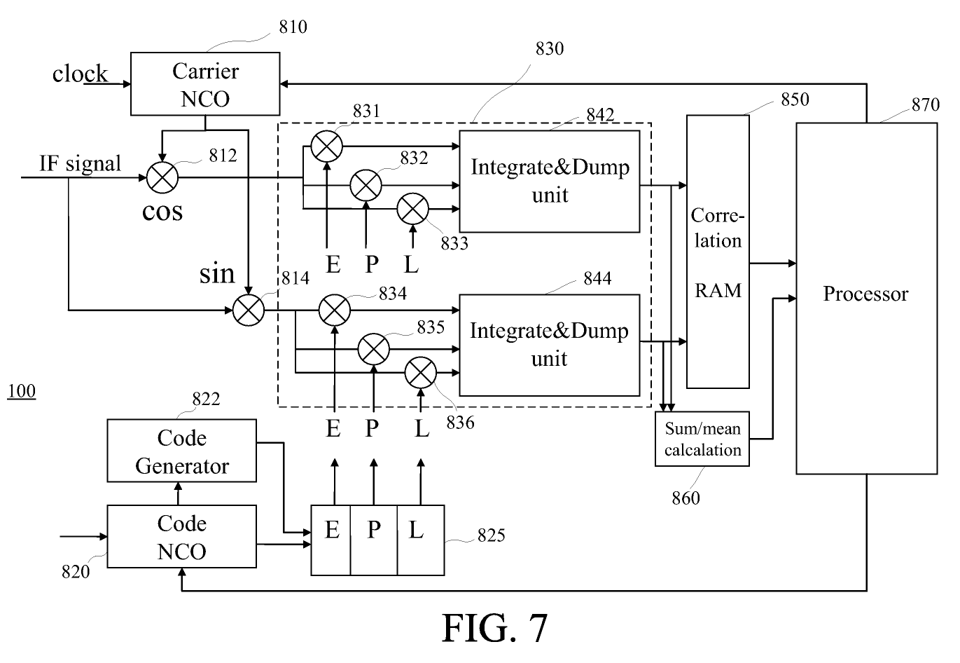

FIG. 6 is a flow chart showing a GNSS satellite signal handling method in accordance with an embodiment of the present invention. FIG. 7 is a block diagram showing a correlator 100 of a GNSS receiver in accordance with an embodiment of the present invention. In step S710, incoming data of a signal (e.g. a GPS signal) is mixed with a specific Doppler bin (Doppler hypothesis). Then, the signal is correlated by the correlator 100 of the present invention to obtain correlation results of code chip delay hypotheses on this Doppler bin (step S720). As shown in FIG. 7, the correlator 100 is approximately similar to a common correlator known in this field. The IF signal is down converted by mixing the cosine-phased and sine-phased components of the signal with a carrier output from a carrier NCO (numerically controlled oscillator) 810 by mixers 812 and 814, respectively. The mixed result is a complex signal having in-phase (I) and quadrature (Q) components. The I and Q components are subjected to mixing in mixers 831 to 836 with E/P/L (Early/Prompt/Late) versions of reference PRN code generated by a code generator 822 and delayed by a delay unit 825 to generate de-spread signals. The code generator 822 is controlled by a code NCO 820. The de-spread signals are integrated in integrate and dump units 842 and 844. The mixers 831 to 836 and the integrate and dump units 842, 844 can be considered together as an integration block 830 for the sake of convenience of description. The integration results from the integration block are sent to a memory (correlation RAM) 850 to be accumulated. The accumulated result is passed to a processor 870.

The processor 870 checks if the maximum value of the correlation results exceeds a predetermined detection threshold in step S730. If not, it means that there is no peak is present in the Doppler bin. Then the searching for this Doppler bin is finished, and searching for code chip delays on another Doppler bin is started (step S765). If the maximum value of the correlation results exceeds the threshold, it indicates that a signal peak is found. To prevent false determination of the signal peak, in step S740, a checking operation is executed. In the present embodiment, the correlator 100 has a sum/mean calculation unit 860. The calculation unit 860 receives integration results from the integration and dump units 842 and 844. The calculation unit 860 calculates a mean value of a plurality of code chip hypotheses for the current Doppler bin, and then outputs the mean value to the processor 870. It is noted that the plurality of code chip hypotheses can be some or all of the code chip hypotheses for the current Doppler bin. In addition, it is possible to search several Doppler bins at the same time. When the plurality of code chip hypotheses are a portion of all the code chip hypotheses for the current Doppler bin, a specific range or selected ones of all the code chip hypotheses for the current Doppler bin can be included. Reference values of unpolluted and polluted Doppler bins can be obtained by gathering statistics experimental data and stored in the processor 870 in advance. The mean value calculated by the calculation unit 860 is compared with the reference values by the processor 870 to determine whether the current Doppler bin is polluted or not. For example, if the mean of the correlation values for the Doppler bin is higher than the noise floor by 2 dB, then it is determined that this Doppler bin is polluted. It is noted that in addition to mean value, other statistical values such as sum or standard deviation of correlation results of plural code phase hypotheses can also be used to determine the existence of interference, such as general jamming or cross-correlations caused by signals from other GNSS systems or different PRN of the same GNSS system.

In another embodiment, in step S740, it is checked that whether there are more than one peak present on the current Doppler bin. For example, if there is another peak not lower than the maximum peak by 15 dB, then it is determined that there are plural peaks existing on the Doppler bin. Accordingly, the Doppler bin is determined as polluted.

In the check step S740, if it is determined that the Doppler bin is not polluted, then the found signal peak is deemed as reliable. That is, the signal is acquired (step S770). However, if it is determined that the Doppler bin is polluted, to avoid false determination for signal peak searching, in accordance with the present invention, the processor 870 raises the detection threshold to a higher value in step S750. After the threshold is set to the new value, in step S760, it is checked again whether the maximum value of the correlation results exceeds the new threshold. If so, the signal is acquired. If not, the search for the Doppler bin is finished and the process goes to step S765.

In determining whether there is jamming or not, the statistical value (e.g. the mean value) of the correlation results can be gathered from arbitrary or selected plural code chips, from a specific range of code chips, or from all the code chips of the current Doppler bin. Therefore, by using the present invention, effective, efficient and reliable signal search can be achieved with limited cost.

By using the present invention, it is easy to check whether a Doppler bin is polluted with interference or not. Further, if the Doppler bin is determined as polluted, the probability of false determination of signal peak searching is reduced by raising the threshold to a higher value. The threshold is to be compared with the found peak to determine whether signal acquisition is achieved. This can be implemented by a built-in program of the processor 870, the cost thereof is quite low.

While the preferred embodiment of the present invention has been illustrated and described in details, various modifications and alterations can be made by persons skilled in this art. The embodiment of the present invention is therefore described in an illustrative but not in a restrictive sense. It is intended that the present invention should not be limited to the particular forms as illustrated, and that all modifications and alterations which maintain the spirit and realm of the present invention are within the scope as defined in the appended claims.

What is claimed is:

1. A GNSS (Global Navigation Satellite System) satellite signal handling method comprising steps of:
receiving a GNSS satellite signal;
calculating correlation results of a plurality of code chip hypotheses for a specific Doppler bin; and
analyzing said correlation results to determining whether said specific Doppler bin is polluted with interference.

2. The method of claim 1, wherein the analyzing steps comprises:
gathering statistics of said correlation results to obtain a statistical value; and
determining whether said specific Doppler bin is polluted with interference according to said statistical value.

3. The method of claim 2, wherein said statistical value is compared with a reference to determine whether said specific Doppler bin is polluted with interference or not.

4. The method of claim 2, wherein said statistical value is any selected from a group consisted of at least a mean value of the correlations results, a sum of the correlations results and a standard deviation of the correlations results.

5. The method of claim 2, wherein said plurality of code chip hypotheses comprise some of all the code chip hypotheses for the specific Doppler bin.

6. The method of claim 2, wherein said plurality of code chip hypotheses comprise all the code chip hypotheses for the specific Doppler bin.

7. The method of claim 1, wherein the analyzing step comprises:
checking if there are more than a predetermined number of peaks within the correlation results; and
determining whether said specific Doppler bin is polluted with interference according to the checking result, wherein said specific Doppler bin is determined as polluted if there are more than the predetermined number of peaks.

8. The method of claim 7, wherein a difference between each two of the peaks for the polluted Doppler bin is less than a predetermined value.

9. The method of claim 7, wherein a ratio between each two of the peaks for the polluted Doppler bin is less than a predetermined value.

10. The method of claim 1, further comprising:
checking if the maximum value of the correlation results exceeds a threshold with an original level; and
raising said threshold to a predetermined level higher than the original level if the specific Doppler bin is determined as polluted.

11. The method of claim 1, wherein correlation results of code chip hypotheses for a plurality of specific Doppler bins are calculated at the same time.

12. A correlator comprising:
an integration block for calculating correlation results of a plurality of code chip hypotheses for a specific Doppler bin; and
a processor for analyzing said correlation results to determine whether said specific Doppler bin is polluted with interference.

13. The correlator of claim 12, further comprising a calculation unit for calculating a statistical value of a plurality ones of the correlation results for a specific Doppler bin, wherein the processor determines whether said specific Doppler bin is polluted with interference or not by comparing said statistical value to a reference.

14. The correlator of claim 13, wherein said statistical value is any selected from a group consisted of at least a mean value of the correlations results, a sum of the correlations results and a standard deviation of the correlations results.

15. The correlator of claim 13, wherein said plurality of code chip hypotheses comprise some of all the code chip hypotheses for the specific Doppler bin.

16. The correlator of claim 13, wherein said plurality of code chip hypotheses comprise all the code chip hypotheses for the specific Doppler bin The correlator of claim 12, wherein the processor checks if there are more than a predetermined number of peaks within the correlation results, and determines whether said specific Doppler bin is polluted with interference according to the checking result, wherein said specific Doppler bin is determined as polluted if there are more than the predetermined number of peaks.

17. The correlator of claim 16, wherein a difference between each two of the peaks for the polluted Doppler bin is less than a predetermined value.

18. The correlator of claim 16, wherein a ratio between each two of the peaks for the polluted Doppler bin is less than a predetermined value.

19. The correlator of claim 12, wherein said processor checks whether the maximum value of the correlation results exceeds a threshold with an original level and determines acquisition is done if the maximum value exceeds said threshold, and said processor raises said threshold to a level higher than the original level when said specific Doppler bin is determined as polluted with interference. and

20. The correlator of claim 19, wherein the processor checks whether the maximum value of the correlation results exceeds the raised threshold to determine if the acquisition is truly done.

21. The correlator of claim 12, wherein the integration block calculates correlation results of code chip hypotheses for a plurality of specific Doppler bins are calculated at the same time.
